(19) United States
(12) Patent Application Publication
(10) Pub. No.: US 2005/0242704 A1
(43) Pub. Date: Nov. 3, 2005

(54) Electron emission device

(76) Inventors: Byong-Gon Lee, Suwon-si (KR); Sang-Ho Jeon, Suwon-si (KR)

Correspondence Address: CHRISTIE, PARKER & HALE, LLP, PO BOX 7068, PASADENA, CA, 91109-7068, US

(21) Appl. No.: 11/117,781

(22) Filed: Apr. 28, 2005

(30) Foreign Application Priority Data
Apr. 29, 2004 (KR) 10-2004-0029994

(51) Int. Cl. H01J 63/04

(52) U.S. Cl. 313/495; 313/496

(57) ABSTRACT

An electron emission device includes first and second substrates facing each other, first and second electrodes and electron emission regions formed on the first substrate, and an anode electrode and phosphor layers formed on the second substrate. A correction electrode is disposed between the first and second substrates that has a first sub-electrode with comb tooth portions arranged on one side of the electron emission regions, and a second sub-electrode with comb tooth portions on the opposite side.

### CROSS REFERENCE TO RELATED APPLICATION

This application claims priority to and the benefit of Korean Patent Application No. 10-2004-0029994 filed on Apr. 29, 2004 in the Korean Intellectual Property Office, the entire content of which is incorporated herein by reference.

### BACKGROUND OF THE INVENTION

(a) Field of the Invention

The present invention relates to an electron emission device, and in particular, to an electron emission device which prevents the landing characteristics of emitted electrons on corresponding pixels from being deteriorated due to the shrinkage/expansion error of the first and second substrates during the thermal treatment process or due to misalignment between the first and second substrates.

(b) Description of Related Art

Generally, electron emission devices are flat panel display devices which display desired images by striking the electrons emitted from the first substrate side against the phosphor layer formed on the second substrate, and are classified into a first type where a hot cathode is used as an electron emission source and a second type where a cold cathode is used as the electron emission source.

Among the second type of electron emission devices, a field emitter array (FEA) type, a surface conduction emission (SCE) type, a metal-insulator-metal (MIM) type, and a metal-insulator-semiconductor (MIS) type are known.

The MIM type and the MIS type electron emission devices have a metal/insulator/metal (MIM) electron emission structure and a metal/insulator/semiconductor (MIS) electron emission structure, respectively. When voltages are applied to the metallic layers or to the metallic and semiconductor layers, electrons migrate and are accelerated from the metallic layer or the semiconductor layer having a high electric potential to the metallic layer having a low electric potential, thereby producing electron emission.

The SCE type electron emission device includes first and second electrodes formed on a substrate and facing each other, and a conductive thin film disposed between the first and second electrodes. Micro-cracks are made at the conductive thin film to form electron emission regions. When voltages are applied to the electrodes, an electric current flows on the surface of the conductive thin film, and electrons are emitted from the electron emission regions.

The FEA type electron emission device is based on the principle that when a material having a low work function or a high aspect ratio is used as an electron emission source, electrons are easily emitted from the material due to the electric field in vacuum. A sharp-pointed tip structure based on molybdenum (Mo) or silicon (Si), or a carbonaceous material, such as carbon nanotube, graphite and diamond-like carbon, has been developed to be used as the electron emission source.

With the above-structured electron emission device, when the assembling location is not correctly controlled during the process of assembling the first and second substrates with each other, misalignment occurs between the electron emission regions and the phosphor layers.

For instance, with the FEA type electron emission device, as shown in FIGS. 18 and 19, a second substrate 4 with phosphor layers 8 is assembled to a first substrate 2 with cathode and gate electrodes 3 and 6 shifted toward one side of the normal position. As a result, the location of the electron emission regions 6 formed on the cathode electrodes 3 of the first substrate 2 is deviated from the location of the phosphor layers 8 of the second substrate 4 so that the phosphor layers 8 are shifted toward one side or are biased with respect to the electron emission regions 6. In this case, some of the electrons emitted from the electron emission regions 6 do not reach the corresponding phosphor layers 8, but instead land on the black layers or the neighboring incorrect color phosphor layers 8, thereby deteriorating the luminance or the color representation.

Furthermore, as shown in FIG. 20, when the second substrate 4 is assembled to the first substrate 2 while being rotated at an angle with respect thereto, the electron emission regions 6 and the phosphor layers 8 are partially misaligned with respect to each other, thereby deteriorating the uniformity in color representation and luminance.

As shown in FIG. 21, even when the shrinkage/expansion rates of the first and second substrates 2 and 4 are different from each other, the electron emission regions 6 and the phosphor layers 8 are partially misaligned with respect to each other so that the uniformity in color representation and luminance is deteriorated.

### SUMMARY OF THE INVENTION

In one exemplary embodiment of the present invention, there is provided an electron emission device which prevents the landing characteristic of the emitted electrons per corresponding pixels from being deteriorated due to the misalignment between the first and second substrates occurring during the assembling process or due to the deviation in shrinkage/expansion of the first and second substrates during the thermal treatment process, thereby enhancing the uniformity in luminance and color representation.

In an exemplary embodiment of the present invention, the electron emission device includes first and second substrates facing each other with a predetermined distance therebetween, and first and second electrodes formed on the first substrate such that the first and second electrodes are not short-circuited with each other. The electron emission device also includes electron emission regions formed on the first substrate, a correction electrode disposed between the first and second substrates, an anode electrode disposed between the second substrate and the correction electrode, and phosphor layers disposed adjacent to the anode electrode. The phosphor layers have a predetermined pattern. The correction electrode includes a comb-shaped first sub-electrode with a plurality of comb tooth portions arranged at one side of the electron emission regions, and a comb-shaped second sub-electrode with a plurality of comb tooth portions arranged at an opposite side of the electron emission regions.

The phosphor layers may include phosphor layer stripes, and the comb tooth portions of the first sub-electrode and the comb tooth portions of the second sub-electrode may extend along a length of the phosphor layer stripes.

The first and second sub-electrodes may have voltage application members placed at one end of the respective comb tooth portions and interconnecting the respective comb tooth portions, and the voltage application members of the first and second sub-electrodes may be placed opposite each other while extending perpendicular to the length of the phosphor layer stripes.

Within the correction electrode, the same voltage or different voltages may be applied to the first and second sub-electrodes to control directions of focusing and migration of electron beams emitted from the electron emission regions.

### BRIEF DESCRIPTION OF THE DRAWINGS

The above and other features of the present invention will become more apparent by describing exemplary embodiments thereof in detail with reference to the accompanying drawings in which:

FIG. 1 is a partial exploded perspective view of an electron emission device according to a first exemplary embodiment of the present invention;

FIG. 2 is a partial cross-sectional view of the electron emission device according to the first exemplary embodiment of the present invention shown in FIG. 1;

FIG. 3 is a partial cross-sectional view of an electron emission device according to a second exemplary embodiment of the present invention;

FIG. 4 is a partial plan view of the electron emission device according to the second embodiment of the present invention shown in FIG. 3;

FIG. 5 is a plan view of an electron emission device according to an exemplary embodiment of the present invention, which schematically illustrates a normal alignment state of electron emission regions and phosphor layers;

FIG. 6 is a partial cross-sectional view of the electron emission device shown in FIG. 4, which schematically illustrates a normal alignment state of electron emission regions and phosphor layers;

FIG. 7 is a plan view of an electron emission device according to an exemplary embodiment of the present invention, which schematically illustrates an alignment state of phosphor layers that are biased or shifted toward one side with respect to electron emission regions;

FIG. 8 is a partial cross-sectional view of the electron emission device shown in FIG. 7;

FIG. 9 is a control signal graph illustrating a pattern of voltages applied to first and second sub-electrodes of the electron emission device shown in FIG. 7;

FIG. 10 is a control signal graph illustrating another pattern of voltages applied to the first and second sub-electrodes of the electron emission device shown in FIG. 7;

FIG. 11 is a plan view of the electron emission device according to an exemplary embodiment of the present invention, which schematically illustrates an alignment state of phosphor layers rotated at an angle with respect to electron emission regions;

FIG. 12 is a control signal graph illustrating a pattern of voltages applied to first and second sub-electrodes of the electron emission device shown in FIG. 11;

FIG. 13 is a control signal graph illustrating another pattern of voltages applied to the first and second sub-electrodes of the electron emission device shown in FIG. 11;

FIG. 14 is a plan view of an electron emission device according to an exemplary embodiment of the present invention, which schematically illustrates an alignment state of a correction electrode rotated at an angle with respect to electron emission regions;

FIG. 15 is a plan view of an electron emission device according to an exemplary embodiment of the present invention, which schematically illustrates an alignment state of a correction electrode biased or shifted toward one side with respect to electron emission regions;

FIG. 16 is a control signal graph illustrating a pattern of voltages applied to first and second sub-electrodes of the electron emission device shown in FIG. 15;

FIG. 17 is a control signal graph illustrating another pattern of voltages applied to first and second sub-electrodes of the electron emission device shown in FIG. 15;

FIG. 18 is a plan view of an FEA-type electron emission device according to prior art, which schematically illustrates an alignment state of phosphor layers biased or shifted toward one side with respect to electron emission regions;

FIG. 19 is a partial cross-sectional view of the electron emission device shown in FIG. 18, which schematically illustrates an alignment state of phosphor layers biased or shifted toward one side with respect to electron emission regions;

FIG. 20 is a plan view of an FEA-type electron emission device according to prior art, which schematically illustrates an alignment state of phosphor layers rotated at an angle with respect to electron emission regions; and

FIG. 21 is a plan view of an FEA-type electron emission device according to prior art, which schematically illustrates an misalignment state between electron emission regions and phosphor layers due to the difference in shrinkage/expansion between first and second substrates.

### DETAILED DESCRIPTION

The present invention will be described more fully hereinafter with reference to the accompanying drawings, in which exemplary embodiments of the invention are shown.

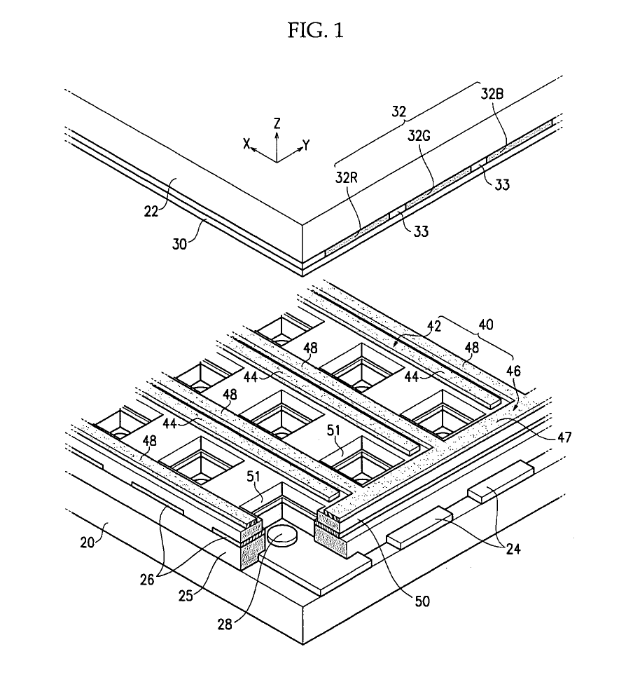

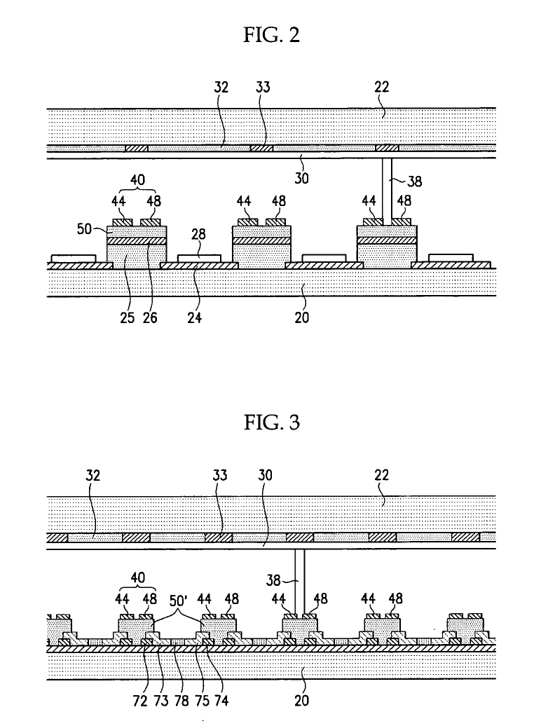

As shown in FIGS. 1 and 2, an electron emission device includes first and second substrates 20 and 22 facing each other with a predetermined distance therebetween. First and second electrodes 24 and 26 are formed on the first substrate 20 with a first insulating layer 25 formed therebetween. Electron emission regions 28 are formed on the first electrodes 24. Phosphor layers 32 are formed on the second substrate 22 with a predetermined pattern, and an anode electrode 30 is formed on the phosphor layers 32. A correction electrode 40 is disposed between the first and second substrates 20 and 22.

The correction electrode 40 increases the focusing capacity of the electron beams emitted from the electron emission regions 28. The correction electrode 40 may be formed on the second electrode 26 by way of deposition or printing with a second insulating layer 50 formed therebetween, or may be formed as a grid plate disposed between the first and second substrates 20 and 22. The grid plate may be formed with a metallic plate having a plurality of comb tooth portions 44 and 48. Electron beam passage holes 51 are formed through the second insulating layer 50 at locations corresponding to the electron emission regions 28.

The first and second electrodes 24 and 26 (i.e. cathode and gate electrodes) are stripe-patterned, and arranged perpendicular to each other. Electron beam passage holes 51 are also formed through the second electrodes 26 and the first insulating layer 25 to allow the electron emission regions 28 on the first electrodes 24 to emit electrons. The electron emission regions 28 are formed on the first electrodes 24 within the electron beam passage holes 51 at crossed regions of the first and second electrodes 24 and 26.

The electron emission regions 28 are formed with a material capable of emitting electrons under the application of an electric field, such as a carbonaceous material and/or a nanometer-sized material. The electron emission regions 28 may be formed with carbon nanotube, graphite, graphite nanofiber, diamond, diamond-like carbon, C₆₀, silicon nanowire, or any suitable combination thereof. The electron emission regions 28 may be formed through screen printing, direct growth, chemical vapor deposition, or sputtering.

Further, the electron emission regions 28 may be formed with various shapes, such as a cone, a wedge or a thin film edge.

It is explained above that the first electrodes 24 are formed on the first substrate 20, and the second electrodes 26 are formed on the first electrodes 24 with the insulating layer 25 formed therebetween. It is also possible that the second electrodes, being the gate electrodes, are formed on the first substrate, and the first electrodes, being the cathode electrodes, are formed on the second electrodes with an insulating layer formed therebetween. In this case, the correction electrode is formed on the first electrodes with a second insulating layer formed therebetween.

The phosphor layers 32 and black layers 33 are formed on a surface of the second substrate 22 facing the first substrate 20, and the anode electrode 30 is formed on the phosphor layers 32 and the black layers 33 with an aluminum-based metallic layer. As shown in FIG. 1, the phosphor layers 32 are structured such that a red phosphor layer 32R, a green phosphor layer 32G and a blue phosphor layer 32B are alternately arranged with a predetermined distance therebetween, in the direction of the first electrodes 24.

The anode electrode 30 receives a high voltage for accelerating the electron beams, and increases the screen luminance by reflecting visible rays radiated from the phosphor layers 32 toward the first substrate 20 back toward the second substrate 22. The anode electrode may be formed with a transparent conductive layer based on indium tin oxide (ITO), instead of being formed from a metallic layer. In this case, the transparent anode electrode can be formed between a surface of the phosphor layers and the black layers and the second substrate, and may be patterned with a plurality of portions.

The first and second substrates 20 and 22 are sealed to each other with a predetermined distance between them using a sealing material (a sealant) such that the second electrodes 26 and the phosphor layers 32 extend perpendicular to each other. The inner space between the first and second substrates 20 and 22 is exhausted to be in a vacuum state.

In order to maintain a constant distance between the first and second substrates 20 and 22, spacers 38 are arranged between the first and second substrates 20 and 22 with a predetermined distance therebetween. The spacers 38 should be located at the non-light emission area where the black layers are placed.

The electron emission device is driven by applying predetermined voltages to the first electrodes 24, the second electrodes 26, the correction electrode 40, and the anode electrode 30. When the voltages are applied to the respective electrodes, electric fields are formed around the electron emission regions 28 due to the voltage difference between the first and second electrodes 24 and 26, and electrons are emitted from the electron emission regions 28. The emitted electrons are attracted by the voltage applied to the anode electrode 30, and are directed toward the second substrate 22 while being focused by the voltage applied to the correction electrode 40. The electrons are attracted by the high voltage applied to the anode electrode 30, and collide against the phosphor layers 32 at corresponding pixels.

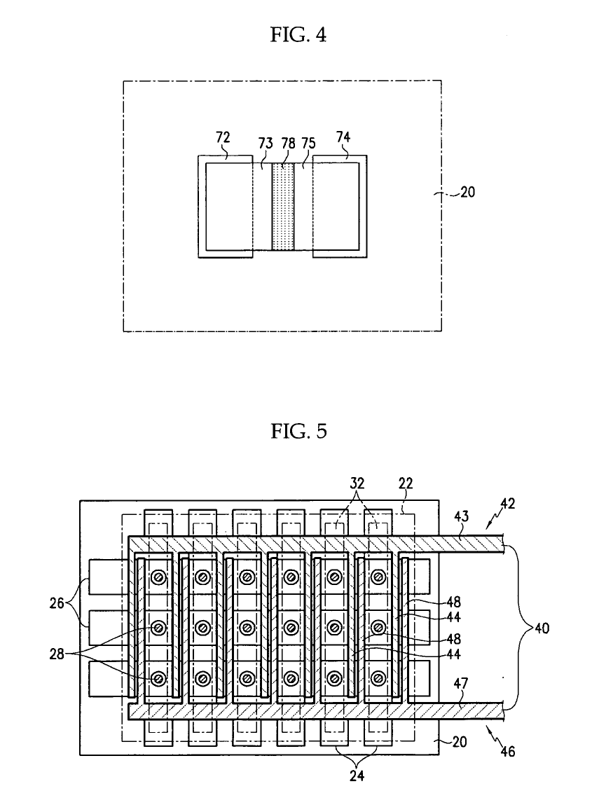

With an electron emission device according to another exemplary embodiment of the present invention, as shown in FIGS. 3 and 4, first and second substrates 20 and 22 face each other with a predetermined distance therebetween, and first and second electrodes 72 and 74 are formed on the first substrate 20 while being spaced apart from each other at a predetermined distance. Electron emission regions 78 are electrically connected to the first and second electrodes 72 and 74. Phosphor layers 32 are formed on the second substrate 22 with a predetermined pattern. An anode electrode 30 is formed on the phosphor layers 32. A correction electrode 40 is disposed between the first and second substrates 20 and 22 and is formed on an insulating layer 50′.

The first and second electrodes 72 and 74 are formed on the first substrate 20 and are located in the same plane.

First and second conductive layers 73 and 75 are formed on the first and second electrodes 72 and 74 while partially covering them such that the first and second electrodes 72 and 74 may be positioned close to each other. Electron emission regions 78 are disposed between the first and second conductive layers 73 and 75 while being connected thereto. Accordingly, the electron emission regions 78 are electrically connected to the first and second electrodes 72 and 74 via the first and second conductive layers 73 and 75, respectively.

When voltages are applied to the first and second electrodes 72 and 74, a surface conduction electron emission occurs which forms a current flow in a direction parallel to the surface of the small area thin-filmed electron emission regions 78 via the first and second conductive layers 73 and 75. The distance between the first and second electrodes 72 and 74 is established, for example, to be about several tens of nanometers to several hundreds of micrometers.

The first and second electrodes 72 and 74 may be formed with various materials having an electrical conductivity, such as metals like nickel (Ni), chromium (Cr), gold (Au), molybdenum (Mo), tungsten (W), platinum (Pt), titanium (Ti), aluminum (Al), copper (Cu), palladium (Pd), silver (Ag), and alloys thereof, a metallic oxide-based printed conductor, and an ITO-based transparent electrode.

The first and second conductive layers 73 and 75 are formed with a fine-grained thin film using a conductive material, such as nickel (Ni), gold (Au), platinum (Pt), and palladium (Pd).

The electron emission regions 78 should be formed with graphite-like carbon or a carbon compound. Further, the electron emission regions may be formed with carbon nanotube, graphite, graphite nanofiber, diamond, diamond-like carbon, C₆₀, silicon nanowire, or any suitable combination thereof.

Specific constructions or processing steps not illustrated in relation to the previous embodiments of the present invention may be realized or performed using the structure of the FEA type electron emission device or the SCE type electron emission device. Further, the structure of the electron emission device of the present invention may be applied to the FEA type electron emission device, the SCE type electron emission device, and other electron emission devices.

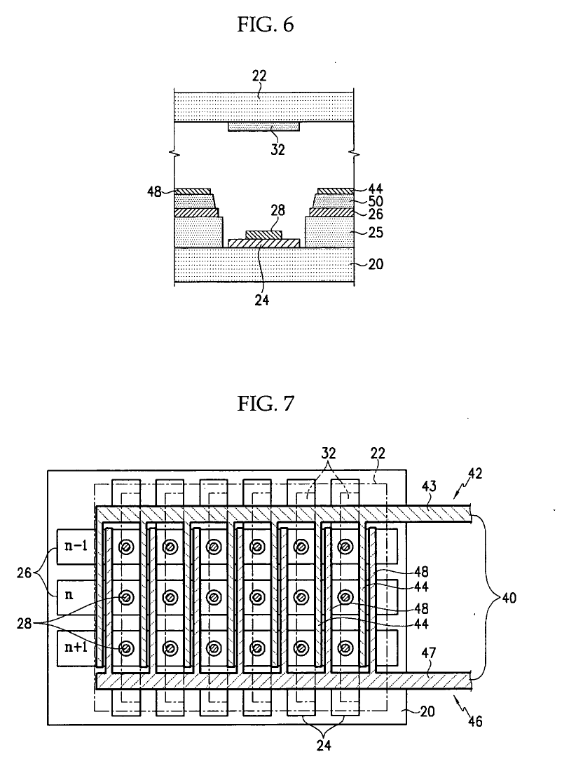

As shown in FIGS. 5 and 6, the correction electrode 40 includes a pair of comb-shaped sub-electrodes 42 and 46 Further, the correction electrode 40 is structured such that comb tooth portions 44 of the first sub-electrode 42 and comb tooth portions 48 of the second sub-electrode 46 face each other with the corresponding comb tooth portions lying parallel to one another. Each of the electron emission regions 28 is located between one of the comb tooth portions 44 and one of the comb tooth portions 48.

For example, the comb tooth portion 44 of the first sub-electrode 42 and the comb tooth portion 48 of the second sub-electrode 46 are alternately arranged between the stripe-patterned first electrodes 24. That is, the comb tooth portion 44 of the first sub-electrode 42 and the comb tooth portion 48 of the second sub-electrode 46 are located between two neighboring first electrodes 24 while being positioned closer to the corresponding first electrodes 24, respectively.

For correction electrode 40, the comb tooth portions 44 of the first sub-electrode 42 and the comb tooth portions 48 of the second sub-electrode 46 are longitudinally formed along the length of the stripe-patterned phosphor layers 32.

The comb tooth portions 44 of the first sub-electrode 42 as well as the comb tooth portions 48 of the second sub-electrodes 46 are connected to each other by way of a pair of voltage application members 43 and 47 placed opposite each other. The voltage application members 43 and 47 are longitudinally formed perpendicular to the length of the phosphor layers 32, and positioned at both ends of the first electrodes 24. The first and second sub-electrodes 42 and 46 are arranged such that they are not short-circuited with each other.

With the correction electrode 40, the same voltage or different voltages are applied to the first and second sub-electrodes 42 and 46 to control the directions of focusing and migration of the electron beams emitted from the electron emission regions 28. That is, different voltages are applied to the first and second sub-electrodes 42 and 46 in order to control the directions of focusing and migration of the electron beams.

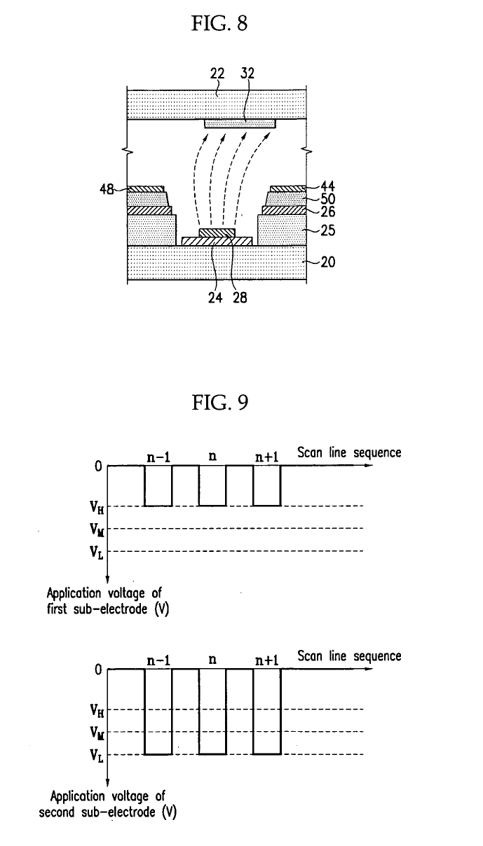

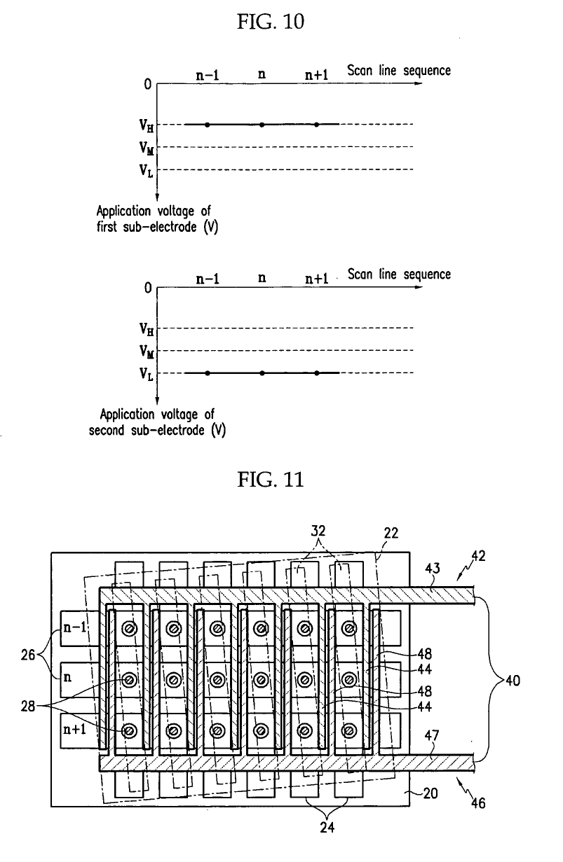

As shown in FIGS. 7 and 8, when a misalignment occurs during the assembly of the first and second substrates 20 and 22, the phosphor layers 32 may be shifted toward one side of the electron emission regions 28. Then, as shown in FIGS. 9 and 10, different driving voltages are applied to the first and second sub-electrodes 42 and 46 to counter the effect of the misalignment.

When the phosphor layers 32 are horizontally shifted toward the first sub-electrode 42 and biased to the right of the electron emission regions 28, as shown in FIG. 9, a relatively high voltage V_{H} is applied to the comb tooth portions 44 via the voltage application member 43 of the first sub-electrode 42, and a relatively low voltage V_{L} is applied to the comb tooth portions 48 via the voltage application member 47 of the second sub-electrode 46. As a result, the electrons emitted from the electron emission regions 28 are biased toward the first sub-electrode 42 receiving the relatively high voltage V_{H} due to the relatively repulsive force of the comb tooth portions 48 of the second sub-electrode 46 and the relatively attractive force of the comb tooth portions 44 of the first sub-electrode 42. These electrons are forced to migrate toward the phosphor layers 32 of the second substrate 22, thereby colliding against the corresponding phosphor layers 32.

That is, a relatively high voltage V_{H} is applied to the first sub-electrode 42 where the comb tooth portions 44 are positioned close to the vertical sides of the phosphor layers 32, and a relatively low voltage V_{L} to the second sub-electrode 46 where the comb tooth portions 48 are positioned far from the vertical sides of the phosphor layers 32, thereby forming asymmetrical electric fields.

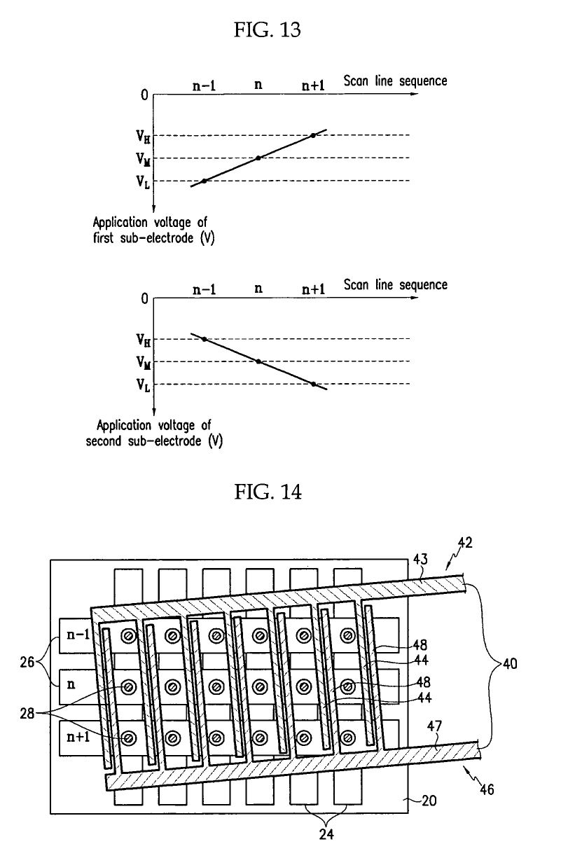

As shown in FIG. 9, voltage application to the first and second sub-electrodes 42 and 46 may be pulse-typed where the voltages are sequentially applied to the pixels. Alternatively, as shown in FIG. 10, voltage application may be uniform where the voltages are wholly applied thereto. In another alternative embodiment, shown in FIG. 13, voltage application may vary continuously and linearly.

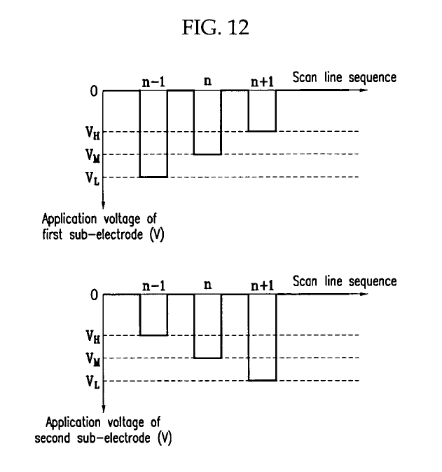

As shown in FIG. 11, when the second substrate 22 is assembled with the first substrate 20 while being rotated at an angle with respect to the latter in the counter-clockwise direction, the phosphor layers 32 are also rotated at an angle with respect to the electron emission region 28 in the counter-clockwise direction. In such a case, as shown in FIG. 12, when data signals are applied to the (n−1)th scan line of the second electrodes 26, a relatively low voltage V_{L} is applied to the first sub-electrode 42, and a relatively high voltage V_{H} to the second sub-electrode 46.

When the different voltages are applied to the first and second sub-electrodes 42 and 46, the electrons emitted from the electron emission regions 28 are drawn toward the second sub-electrode 46, which receives the relatively high voltage V_{H} due to the repulsive force of the comb tooth portions 44 of the first sub-electrode 42 and the relatively attractive force of the comb tooth portions 48 of the second sub-electrode 46. As a result, the emitted electrons migrate toward the phosphor layers 32 of the second substrate 22, thereby colliding against the relevant phosphor layers 32.

As shown in FIG. 12, when data signals are applied to the nth scan line of the second electrodes 26, the same voltage V_{M} is applied to the first and second sub-electrodes 42 and 46. As a result, the electrons emitted from the electron emission regions 28 migrate toward the phosphor layers 32 of the second substrate 22 along their normal trajectories, thereby colliding against the relevant phosphor layers 32.

Further, as shown in FIG. 12, when data signals are applied to the (n+1)th scan line of the second electrodes 26, a relatively low voltage V_{L} is applied to the second sub-electrode 46, and a relatively high voltage V_{H} is applied to the first sub-electrode 42. When the different voltages are applied to the first and second sub-electrodes 42 and 46, the electrons emitted from the electron emission regions 28 are drawn toward the first sub-electrode 42, that receive the relatively high voltage V_{H} due to the repulsive force of the comb tooth portions 48 of the second sub-electrode 46 and the attractive force of the comb tooth portions 44 of the first sub-electrode 42. The emitted electrons migrate toward the phosphor layers 32 of the second substrate 22, thereby colliding against the corresponding phosphor layers 32.

As described above, when data signals are applied to the scan lines, the voltages applied to the first and second sub-electrodes 42 and 46 are determined in proportion to the degree of rotation of the phosphor layers 32 with respect to the electron emission regions 28 in order to correct the misalignment between the phosphor layers 32 and the electron emission regions 28.

What is explained above in relation to only three scan lines, is applicable to larger numbers of scan lines. A possible misalignment between the phosphor layers 32 and the electron emission regions 28 may be corrected by altering the voltages applied to the first and second sub-electrodes 42 and 46 in various different manners.

Further, as shown in FIG. 13, it is also possible to correct the misalignment between the phosphor layers 32 and the electron emission regions 28, by linearly varying the voltages applied to the first and second sub-electrodes 42 and 46.

With the electron emission device of the present invention, when the voltages applied to the first and second sub-electrodes 42 and 46 of the correction electrode 40 are differentiated per corresponding pixels, the misalignment between the electron emission regions 28 and the phosphor layers 32 occurring due to the difference in shrinkage/expansion between the first and second substrates 20 and 22 may also be corrected. FIG. 20 illustrates an example of such a shrinkage/expansion misalignment.

That is, the voltages applied to the first and second sub-electrodes 42 and 46 are controlled corresponding to the signals applied to the second electrodes 26, and the voltages applied to the first and second sub-electrodes 42 and 46 are controlled corresponding to the signals applied to the first electrodes 24 so that the misalignment between the electron emission regions 28 and the phosphor layers 32 occurring due to the difference in shrinkage/expansion between the first and second substrates 20 and 22 can be corrected.

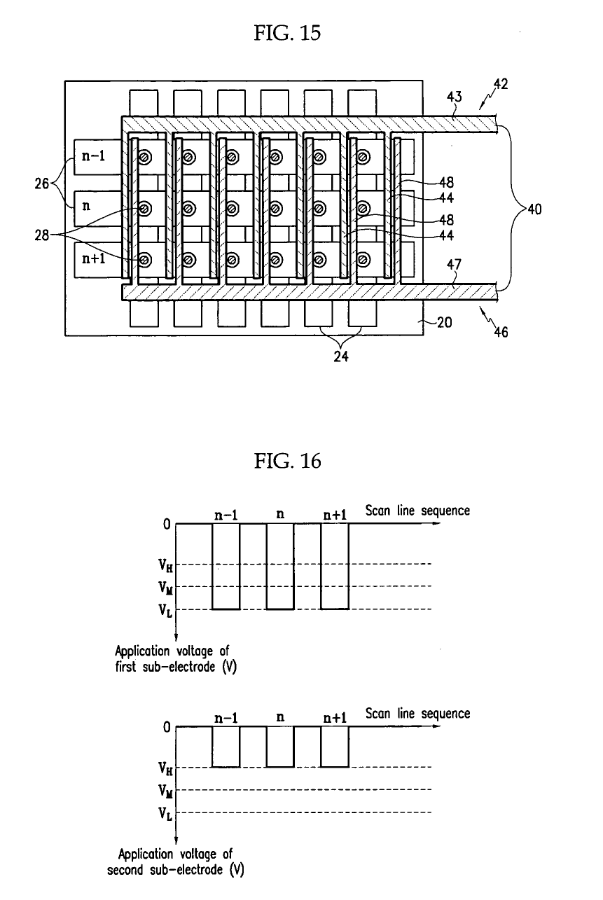

Further, as shown in FIGS. 14 and 15, the possible misalignment between the electron emission regions 28 and the correction electrode 40 occurring during the installation of the correction electrode 40 may be corrected as well.

That is, as shown in FIG. 14, where the correction electrode 40 is rotated at an angle with respect to the electron emission region 28 in the counter-clockwise direction during installation. In this case, as illustrated in FIGS. 12 and 13, predetermined voltages are applied to the first and second sub-electrodes 42 and 46 so that the directions of focusing and migration of the electron beams emitted from the electron emission regions 28 are corrected.

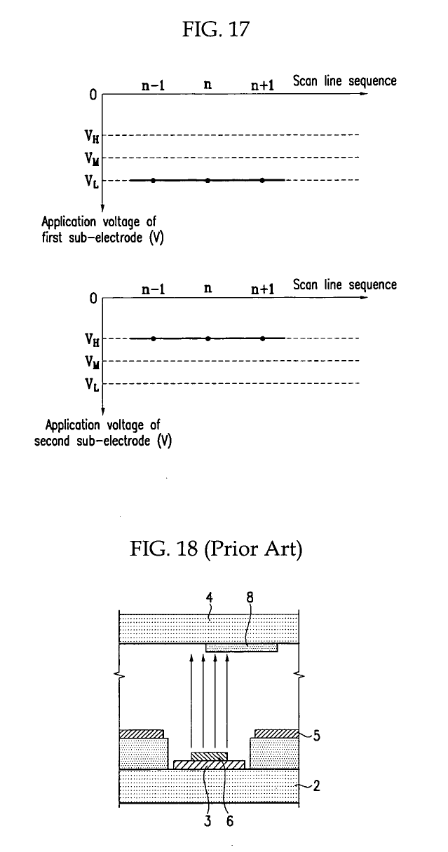

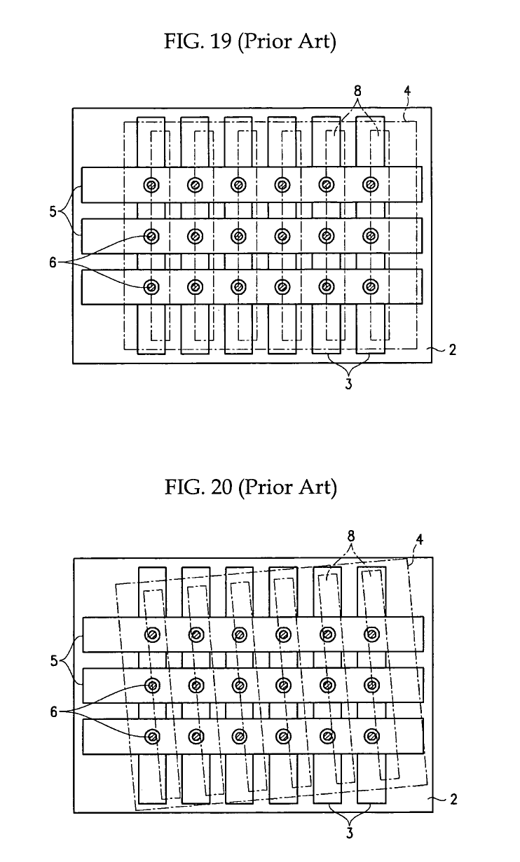

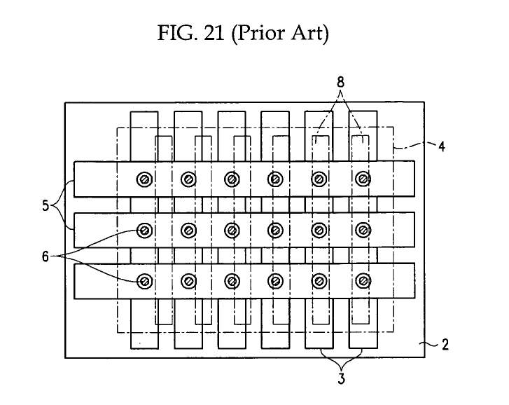

Further, as shown in FIG. 15, the correction electrode 40 can be horizontally shifted to the right of the electron emission regions 28 and installed while being biased or shifted toward one side thereof. For example, in FIG. 15, the comb tooth portions 44 of the first sub-electrode 42 are located far from the electron emission regions 28, and the comb tooth portions 48 of the second sub-electrode 46 are located close to the electron emission regions 28. In that case, as shown in FIGS. 16 and 17, a relatively low voltage V_{L} is applied to the first sub-electrode 42, and a relatively high voltage V_{H} is applied to the second sub-electrode 46 so that the directions of focusing and migration of the electrons emitted from the electron emission regions 28 can be corrected.

When voltages are applied to the first and second sub-electrodes 42 and 46 of the correction electrode 40, the voltages can be selectively applied to the respective scan lines. However, in this case, a burden may be imposed on the IC due to the driving voltage of the correction electrode 40. For this reason, as shown in FIGS. 9, 12 and 16, voltages are applied to the scan lines with a cycle of one frame (1-frame).

With the electron emission device of the present invention, even when misalignment occurs between the first and second substrates during the assembly process, it is not necessary to correct and apply the driving image input signals, but only a tuning process is made during the assembly completion of the product, thereby enhancing the uniformity in luminance and color representation using hardware rather than correcting the driving image input signals.

By way of example, with the conventional structure, as the driving image input signals are corrected and applied to correct the misalignment, an additional memory such as a frame buffer is needed, and a short signal delay is made during the image correction process. However, with the inventive structure, such an additional memory is not needed, and the misalignment can be corrected in real time.

Consequently, with the electron emission device of the present invention, asymmetrical electric fields are formed between the first and second sub-electrodes of the correction electrode in synchronization with the cycles of the scan lines so that the landing of the electrons emitted from the electron emission regions on the phosphor layers can be corrected in a simplified manner, thereby enhancing the uniformity in luminance and color representation.

Although certain exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims and equivalents thereof.

1. An electron emission device comprising:
first and second substrates facing each other with a predetermined distance therebetween;
first and second electrodes formed on the first substrate such that the first and second electrodes are not short-circuited with each other;
electron emission regions formed on the first substrate;
a correction electrode disposed between the first and second substrates;
an anode electrode disposed between the second substrate and the correction electrode;
phosphor layers disposed adjacent to the anode electrode, and having a predetermined pattern; and
wherein the correction electrode comprises a comb-shaped first sub-electrode with a plurality of comb tooth portions arranged at one side of the electron emission regions, and a comb-shaped second sub-electrode with a plurality of comb tooth portions arranged at an opposite side of the electron emission regions.

2. The electron emission device of claim 1,
wherein the phosphor layers comprise phosphor layer stripes, and
wherein the comb tooth portions of the first sub-electrode and the comb tooth portions of the second sub-electrode extend along a length of the phosphor layer stripes.

3. The electron emission device of claim 2,
wherein the first and second sub-electrodes have voltage application members placed at one end of the respective comb tooth portions and interconnecting the respective comb tooth portions, and
wherein the voltage application members of the first and second sub-electrodes are placed opposite each other while extending perpendicular to the length of the phosphor layer stripes.

4. The electron emission device of claim 1 wherein different voltages are applied to the first and second sub-electrodes.

5. The electron emission device of claim 4 wherein a difference between the voltages applied to the first and second sub-electrodes is related to a misalignment between the electron emission regions and the phosphor layers.

6. The electron emission device of claim 4,
wherein the electron emission device operates in scan and frame cycles, and
wherein the voltages applied to the first and second sub-electrodes are differentiated in synchronization with the scan and frame cycles.

7. The electron emission device of claim 4,
wherein the phosphor layers define pixels, and
wherein the voltages applied to the first and second sub-electrodes are differentiated per corresponding pixels.

8. The electron emission device of claim 4 wherein a difference between the voltages applied to the first and second sub-electrodes corresponds to a misalignment between the electron emission regions and the correction electrode.

9. The electron emission device of claim 1 wherein the correction electrode is formed on the first electrode or the second electrode while separated from the first electrode or the second electrode by an insulating layer.

10. The electron emission device of claim 1 wherein the electron emission regions are formed with a material selected from a group consisting of graphite, diamond, diamond-like carbon, carbon nanotube, C₆₀, and any suitable combination thereof.

11. The electron emission device of claim 10,
wherein the first electrodes are arranged on the first substrate with a predetermined distance therebetween,
wherein the second electrodes cross over the first electrodes with an insulating layer therebetween, and
wherein the electron emission regions are formed on portions of the first electrodes that cross over the second electrodes.

12. The electron emission device of claim 10, further comprising:
first and second conductive layers that partially cover the first and second electrodes, respectively;
wherein the first and second electrodes are formed on the first substrate facing each other and separated by a predetermined distance, and
wherein the electron emission regions are formed between the first and second conductive layers.

13. A method of driving an electron emission device, the electron emission device comprising a correction electrode having first and second sub-electrodes disposed between first and second substrates, each sub-electrode having a plurality of comb tooth portions, each of electron emission regions formed on the first substrate being adjacent to one of the comb tooth portions of the first sub-electrode on one side, and one of the comb tooth portions of the second sub-electrode on the other side, the method comprising:
applying voltages to the first and second sub-electrodes to correct trajectories of electrons emitted from the electron emission regions when either phosphor layers or the correction electrode is shifted toward one side of the electron emission regions due to a misalignment made between the first and second substrates during an assembly process of the electron emission device.

14. The method of claim 13 wherein the voltages applied to the first and second sub-electrodes are made in pulses where voltages are sequentially applied to corresponding pixels, or in a linear way where the voltages are applied continuously to the corresponding pixels.

15. The method of claim 14 wherein when the phosphor layers are horizontally shifted toward one side of the electron emission regions, a relatively high voltage is applied to one of the first and second sub-electrodes placed closer to the phosphor layers, and a relatively low voltage is applied to the other one of the sub-electrodes.

16. The method of claim 14,
wherein the electron emission device further comprises at least n+1 scan lines and data signals are sequentially applied to the n+1 scan lines, where n is an integer greater than or equal to 2,
wherein in case the phosphor layers are rotated around an nth scan line among the scan lines at an angle with respect to the electron emission regions in a counter-clockwise direction, a relatively low voltage is applied to the first sub-electrode and a relatively high voltage is applied to the second sub-electrode when data signals are applied to an (n−1)th scan line among the scan lines, wherein a same voltage is applied to the first and second sub-electrodes when the data signals are applied to the nth scan line, and wherein a relatively low voltage is applied to the second sub-electrode and a relatively high voltage is applied to the first sub-electrode when the data signals are applied to an (n+1)th scan line among the scan lines.

17. The method of claim 14,
wherein the electron emission device further comprises at least n+1 scan lines and data signals are sequentially applied to the n+1 scan lines, where n is an integer greater than or equal to 2, and
wherein in case the correction electrode is rotated around an nth scan line among the scan lines at an angle with respect to the electron emission regions in a counter-clockwise direction, a relatively low voltage is applied to the first sub-electrode and a relatively high voltage is applied to the second sub-electrode when the data signals are applied to an (n−1)th scan line among the scan lines, wherein a same voltage is applied to the first and second sub-electrodes when the data signals are applied to the nth scan line, and wherein a relatively low voltage is applied to the second sub-electrode and a relatively high voltage is applied to the first sub-electrode under the application of the data signals to an (n+1)th scan line among the scan lines.

18. The method of claim 14 wherein in case the correction electrode is shifted toward one side of the electron emission regions, a relatively low voltage is applied to one of the first and second sub-electrodes positioned relatively far from the electron emission regions, and a relatively high voltage is applied to the other one of the first and second sub-electrodes.

19. The method of claim 13 wherein the misalignment between the electron emission regions and the phosphor layers occurs due to a difference in shrinkage/expansion between the first and second substrates and is compensated by controlling the voltages applied to the first and second sub-electrodes corresponding to the signals applied to the gate electrodes and the cathode electrodes.

20. The method of claim 13 wherein the voltages are applied to the first and second sub-electrodes with a cycle of one frame (1-frame).
